(19) United States
(12) Patent Application Publication
(10) Pub. No.: US 2017/0158876 A1
(43) Pub. Date: Jun. 8, 2017

(54) METHOD FOR PREVENTING MARINE BIOFOULING BY USING PRINCIPLE OF HARMONIC VIBRATION

(71) Applicant: Jilin University, Changchun City (CN)

(72) Inventors: Limei TIAN, Changchun City (CN); E JIN, Changchun City (CN); Qingpeng KE, Changchun City (CN); Yangeng SHANG, Changchun City (CN); Yinwu LI, Changchun City (CN); Hang SUN, Changchun City (CN); Yan LIU, Changchun City (CN); Luquan REN, Changchun City (CN)

(21) Appl. No.: 15/373,218

(22) Filed: Dec. 8, 2016

(30) Foreign Application Priority Data
Dec. 8, 2015 (CN) 201510897601.1

(51) Int. Cl. C09D 5/16; B63B 59/04

(52) U.S. Cl. CPC C09D 5/1681; B63B 59/04

(57) ABSTRACT

The disclosure provides a method for preventing marine biofouling by using the principle of harmonic vibration. The method includes coating a surface of a device to be disposed in water with an elastic material layer. The elastic material may vibrate harmonically under the influence of the water traveling wave, thereby forming a cosine wave form. Taking “a” as the wavelength of the harmonic vibration, “b” as the amplitude of the harmonic vibration and “L” as the body length of a mussel larva, an algae larva or a barnacle larva, where L/2 is larger than “a” or “b”, the larva will be easily stripped off under the effect of harmonic vibration. The frequency of the cosine wave ranges from 0.02 Hz to 0.1 Hz so that the larva has insufficient time to stay, thereby preventing the larva from attaching.

### CROSS-REFERENCE TO RELATED APPLICATION

This application is related to and claims priority from Chinese Application No. 201510897601.1, filed on Dec. 8, 2015 and entitled “method for preventing marine biofouling by using principle of harmonic vibration”, the entire disclosure of which is hereby incorporated by reference.

Technical Field

The present invention relates to a method for preventing marine biofouling, in particular to a method for preventing biofouling with the principle of harmonic vibration under the stimulus of a fluid medium. Compared with the anti-fouling method in the prior art, this method is green, long-acting and broadly-used.

Background

Biofouling refers to a phenomenon that marine micro-organisms, plants and animals attach to an object immersed into seawater, such as a ship, a submarine, a drilling device, an instrument, a mariculture cage and the like, and have a negative impact on the object. Biofouling leads to a reduced sailing speed of a ship, an increased fuel cost, a blocked seawater pipe, and an unbalanced undersea facility. The damage caused by the biofouling is particularly serious, especially for a large ship. The biofouling may change the surface characteristics of the ship's metal shell, accelerate the corrosion of steels, lead to a damage of the ship's piping system, and impact its normal operation, thereby leading to increased times of the ship's maintenance into the dock, reducing the ship's sailing rate, shortening the ship's service life and the like.

Scientific researches show that the biofouling includes three stages, namely, an initial stage, a developing stage and a stable stage. In the initial stage, the surface of any object immersed into seawater will adsorb a layer of organics within a few minutes to form a conditional film. In the developing stage, bacteria, diatoms and the like sequentially attach to the conditional film and secrete extracellular metabolites to form a micro-biological film. And then, in the stable stage, other prokaryotes, fungus, algae spores and larvae of macro-fouling animals grow in the film to form a complex macro biofouling layer. The conditional film may change the physical and chemical properties of the surface of the base material, so as to form conditions suitable for the attachment of bacteria, microalgae and the like. The forming status and features of the biological film influence the states of the attachment of the macro-organisms. The formation of the conditional film is unavoidable, but the process of forming the micro-biological film and biological film may be artificially influenced. If the process of forming a newborn biological film is effectively suppressed, the subsequent attachment of macro-organisms will be effectively delayed or suppressed.

### SUMMARY

Under such a principle, the present invention is proposed to inhibit the formation of the micro-biological film mainly in the developing stage. In fact, the surface of a living body is not easy to attach. This is due to the surface topography of the solid wall and the staying time for the organism on the solid wall of the living body. The surface topography of the solid wall may influence whether the micro-organisms have a sufficient attachment area, and the staying time may influence whether the micro-organisms can secrete sufficient proteins for adhering to the surface of the solid wall. In the marine fluid medium, the relative movement between the ship body and seawater provides a certain dynamic relationship between the surface of the ship body and micro-organisms. A material with a certain elastic modulus may be coated onto the surface of the ship. Under the effect of waterflow waves, the elastic material may resonate, and provide less attachment area and less static staying time for fouling organisms, which may interfere with attachment of micro-organisms onto the solid surface, thereby suppressing the formation of a biological film and the attachment of macro-organisms, so as to achieve a desired anti-fouling effect. The present invention is based on this antifouling principle.

The present invention intends to provide a method for preventing marine biofouling by using the principle of harmonic vibration.

According to the present invention, the method includes coating a surface of a device to be disposed in water with an elastic material layer. The elastic material may vibrate harmonically under the influence of the water traveling wave, thereby forming a cosine wave form. Taking “a” as the wavelength of the harmonic vibration, “b” as the amplitude of the harmonic vibration and “L” as the body length of a mussel larva, an algae larva or a barnacle larva, where L/2 is larger than “a” or “b”, the larva will be easily stripped off under the effect of harmonic vibration. The frequency of the cosine wave ranges from 0.02 Hz to 0.1 Hz so that the larva has insufficient time to stay, thereby preventing the larva from attaching.

The present invention acts on, for example, mussel larvae, algae larvae and barnacle larvae, whose size is between 0.3 mm and 0.7 mm. Thus, the elastic material layer is designed to have the thickness of 0.5 mm-1 mm so as to achieve a good effect of preventing the marine biofouling.

According to the principle of the present invention, the effect of the present invention is associated with the size of larvae, the elastic modulus of the elastic material, and the frequency of harmonic vibration of the elastic material induced under the influence of the fluid medium. The method of the present invention provides insufficient staying time and attachment area for larvae, so as to achieve detaching.

### BRIEF DESCRIPTION OF THE DRAWINGS

FIG. 1 is a schematic diagram showing the principle of the present invention.

### DETAILED DESCRIPTION OF EMBODIMENTS

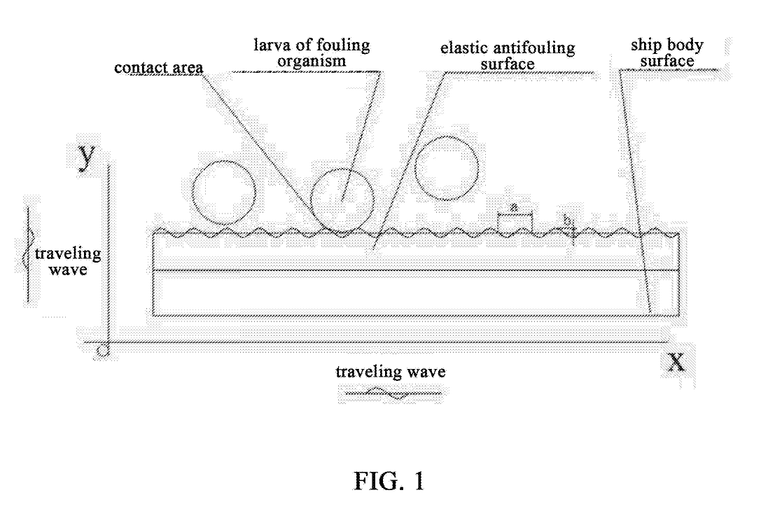

As shown in FIG. 1, in the method of the present invention, the surface-coating material has an elastic modulus selected on the basis of the sailing speed. Such a material may vibrate harmonically under the influence of the seawater traveling wave, thereby forming a cosine wave form. Referring to FIG. 1, “a” represents the wavelength of the harmonic vibration, and “b” represents the amplitude of the harmonic vibration. Supposed that the body length of a mussel larva, an algae larva or a barnacle larva is L, as long as L/2 is larger than “a” or “b”, the larva will be easily stripped off under the effect of harmonic vibration. The frequency of the cosine wave ranges from 0.02 Hz to 0.1 Hz so that the larva has insufficient time to stay, thereby preventing the larva from attaching.

Supposed that the larva has a round shape and the body length of the larva is L, as long as L/2 is larger than “a” or “b”, the larva will be easily stripped off under the effect of harmonic vibration, thereby preventing the larva from attaching.

In an embodiment, Chthamalus Challengeris from Qingdao city in Shandong province of China are provided as the barnacle larvae, whose body length is about 0.7 mm. A certain amount of living barnacle larvae are added to an aquarium in which the marine environment is simulated under laboratory conditions. The temperature, PH value and salinity of the seawater are 25 centigrade, 8.2 and 30 ppt, respectively. When the sailing speed ν is equal to or less than 5 Knot (ν□5 Kn), a material with an elastic modulus Ep equal to or larger than 1.5 MPa and equal to or less than 5 MPa (1.5 MPa≦Ep □5 MPa) is selected to cover the surface of the ship body. After 72 hours the ship is immersed in the water, the detaching effect (rate) on the surface of the selected material can reach 62% through a stereomicroscope counting method. Under the same condition of the temperature, the PH value and the salinity of seawater, when the sailing speed ν is equal to or larger than 5 Knot and equal to or less than 10 Knot (5 Kn □ν□10 Kn), a material with an elastic modulus Ep equal to or larger than 5 MPa and equal to or less than 8.6 MPa (5 MPa≦Ep □8.6 MPa) is selected to cover the surface of the ship body. The detaching effect (rate) can reach 73%.

In another embodiment, Perna Viridis from Zhanjiang city in Guangdong province of China are provided as the mussel larvae, whose body length is about 0.3 mm. A certain amount of living mussel larvae are added to an aquarium in which the marine environment is simulated under laboratory conditions. The temperature, the PH value and the salinity of seawater are 25 centigrade, 7.8 and 27 ppt, respectively. When the sailing speed ν is equal to or less than 5 Knot (ν□5 Kn), a material with an elastic modulus Ep equal to or larger than 2.3 MPa and equal to or less than 4.5 MPa (2.3 MPa≦Ep≦4.5 MPa) is selected to cover the surface of the ship body. After 72 hours the ship is immersed in the water, the detaching effect (rate) on the surface of the selected material can reach 57% through a stereomicroscope counting method. Under the same condition of the temperature, the PH value and the salinity of seawater, when the sailing speed ν is equal to or larger than 5 Knot and equal to or less than 10 Knot (5 Kn≦ν≦10 Kn), a material with an elastic modulus Ep equal to or larger than 5 MPa and equal to or less than 7 MPa (5 MPa≦Ep≦7 MPa) is selected to cover the surface of the ship body. The detaching effect (rate) can reach 64%.

What is claimed is:

1. A device to be disposed in water, comprising:
a body having a surface, the surface being to be immersed at least in part in water; and
an elastic coating disposed on the surface of the body and configured to vibrate harmonically under an influence of a water traveling wave to form a dynamic surface for preventing biofouling in the water.

2. The device according to claim 1, wherein the dynamic surface has a dynamic cosine waveform so that fouling organisms in the water have insufficient area and time to attach to.

3. The device according to claim 2, wherein the dynamic cosine waveform has a frequency of 0.02 Hz to 0.1 Hz.

4. The device according to claim 2, wherein the dynamic cosine waveform satisfy at least one of the following formulas:
L/2>a; and
L/2>b,
wherein L is a length of the fouling organisms, a is a wavelength of the dynamic cosine waveform, and b is an amplitude of the dynamic cosine waveform.

5. The device according to claim 1, wherein the elastic coating has an elastic modulus Ep satisfying the following formula:
1.5 MPa≦Ep≦8.6 MPa.

6. The device according to claim 1, wherein the elastic coating has an elastic modulus Ep of 5 MPa.

7. The device according to claim 1, wherein the elastic coating has a thickness of 0.5 mm-1 mm.

8. The device according to claim 1, wherein the device is a ship.

9. A method for preventing marine biofouling onto a device to be disposed in water, comprising:
coating a surface of the device with an elastic material layer, the surface being to be immersed at least in part in water; and
stimulating the elastic material layer to vibrate harmonically by a water traveling wave, so as to form a dynamic surface of the elastic material layer for preventing biofouling in the water.

10. The method according to claim 9, wherein the dynamic surface has a dynamic cosine waveform so that fouling organisms in the water have insufficient area and time to attach to.

11. The method according to claim 10, wherein the dynamic cosine waveform has a frequency of 0.02 Hz to 0.1 Hz.

12. The method according to claim 10, wherein the dynamic cosine waveform satisfy at least one of the following formulas:
L/2>a; and
L/2>b,
wherein L is a length of the fouling organisms, a is a wavelength of the dynamic cosine waveform, and b is an amplitude of the dynamic cosine waveform.

13. The method according to claim 9, wherein the elastic material layer has an elastic modulus Ep satisfying the following formula:
1.5 Mpa≦Ep≦8.6 Mpa.

14. The method according to claim 9, wherein the elastic material layer has an elastic modulus Ep of 5 MPa.

15. The method according to claim 9, wherein the elastic material layer has a thickness of 0.5 mm-1 mm.

16. The method according to claim 9, wherein the device is a ship.

17. A method for preventing marine biofouling by using principle of harmonic vibration, the method comprising:
coating a surface of a device to be disposed in water with an elastic material layer configured to vibrating harmonically under an influence of a water traveling wave to form a cosine wave;
wherein “a” is set as a wavelength of the harmonic vibration, “b” is set as an amplitude of the harmonic vibration, and “L” is set as a body length of a mussel larva, an algae larva or a barnacle larva;
where L/2 is larger than “a” or “b”, the larva is stripped off the surface of the device under an effect of the harmonic vibration, and a frequency of the cosine wave ranges from 0.02 Hz to 0.1 Hz so that the larva has insufficient time to stay, thereby preventing the larva from attaching to the surface of the device.
